(19) United States
(12) Patent Application Publication
(10) Pub. No.: US 2014/0150969 A1
(43) Pub. Date: Jun. 5, 2014

(54) Device for the manufacture of a bonded component and also a method

(71) Applicants: Heinz Bardenhagen, Stade (DE); Karsten Suessmuth, Stade (DE)

(72) Inventors: Heinz Bardenhagen, Stade (DE); Karsten Suessmuth, Stade (DE)

(21) Appl. No.: 14/235,208

(22) PCT Filed: Jul. 27, 2012
(86) PCT No.: PCT/EP2012/064834

§ 371 Date: Jan. 27, 2014

Related U.S. Application Data
(60) Provisional application No. 61/512,003, filed on Jul. 27, 2011.

(30) Foreign Application Priority Data
Jul. 27, 2011 (DE) 102011079931

(51) Int. Cl. B32B 37/10

(52) U.S. Cl. CPC B32B 37/1018
USPC 156/285; 156/382

(57) ABSTRACT

A device and method for manufacturing a bonded component with fiber-reinforced plastics having at least one base molding tool and at least one molding tool. The bonded component is arranged between the base molding tool and the molding tool. The bonded component has a base laminate and a reinforcement laminate. The molding tool is covered with an aeration material and a vacuum envelope. The vacuum envelope is sealed with respect to the base molding tool. At least one filler element is fitted to each of the two end faces of the base laminate in a gap-free manner. With the filler elements, as well as optionally provided sealing elements, undesirable cavities within the device, as a result of thermal expansion effects of the upper molding tool, as well as any deviations of location and/or size of the base laminate, the reinforcement laminate, and also the molding tool, are significantly reduced.

### CROSS-REFERENCES TO RELATED APPLICATIONS

This application claims the benefit of the U.S. Provisional Application No. 61/512,003, filed on Jul. 27, 2011, and of the German patent application No. 10 2011 079 931.1 filed on Jul. 27, 2011, the entire disclosures of which are incorporated herein by way of reference.

### BACKGROUND OF THE INVENTION

The invention concerns a device for the manufacture of a bonded component with fiber-reinforced plastics with at least one base molding tool and at least one molding tool, wherein the bonded component is arranged between the base molding tool and the molding tool and the bonded component has at least one base laminate and at least one reinforcement laminate, and the molding tool is covered with an aeration material and with a vacuum envelope, wherein the vacuum envelope is sealed with respect to the base molding tool.

For components in which high specific strengths and stiffnesses are required per unit weight, as, for example, in aerospace applications, fiber-reinforced plastics (FRPs) are often deployed. A fiber-reinforced plastic is a material that is formed with a multiplicity of reinforcement fibers that are embedded in a plastic matrix material. At the present time carbon fibers, glass fibers, aramide® fibers, natural fibers, or similar, are deployed as the reinforcement fibers. As a rule the matrix material consists of thermosetting plastics, such as, for example, epoxy resins, polyester resins, phenol resins, or bismaleimide resins (so-called BMI resins). In principle the bonded components can be manufactured with reinforcement fibers that are already pre-impregnated with matrix material (so-called prepreg material), and/or with reinforcement fibers, i.e., fiber products with a suitable geometry, which are only infiltrated, i.e., impregnated, with the matrix material immediately before the curing process.

Complex, integral fiber-reinforced plastic structures usually consist of at least one base laminate with a multiplicity of reinforcing and connecting elements. These elements can be available as fiber-reinforced plastic components that have already been consolidated, as components made of other materials, and also as fiber-reinforced plastic laminates. Fiber-reinforced plastic laminates consist of two or more layers of reinforcement fibers that have been pre-impregnated with a matrix material, and which have not yet been cured. The reinforcement fibers can be available as a unidirectional layer, a woven fabric, a knitted fabric, or as a multi-layer mat. The layers usually have differing primary fiber directions with a course that is preferably aligned with the forces that are occurring.

One variant for the design of components from fiber-reinforced plastic is, for example, a large-format shell with longitudinal stiffeners, in particular I-stringers, or stringers with other cross-sectional geometries, in an integral form of construction. These are constructed from at least one base laminate and reinforcement laminates, such as, for example, stringer laminates, and also partial reinforcements and other features as required.

Shells stiffened with I-stringers in an integral form of construction are components that are often curved in at least one spatial direction. Through the design of the base laminate, the use of reinforcements and insulation material, and also the addition of other elements, components of complex shape ensue, with very different thicknesses and contours between sections. Such shell components find application, for example, in the manufacture of lifting surfaces, ailerons, landing flaps, elevator units, vertical tail units, fuselage shells, or similar items, for the production of aircraft.

For the manufacture of a shell component with integral reinforcement elements, such as, for example, stringers, the stringer laminates are laid down in accordance with a procedure of known prior art—here cited in an exemplary manner—on molding tools provided with means of release, and are shaped on the latter. In an intermediate step a base laminate is laid down on a base molding tool similarly provided with means of release, and is aligned on the latter. The molding tools are then brought together, spatially aligned, and together are laid down as a unit on the base laminate. The whole arrangement is then provided with a vacuum generation system and the device thus created is placed in an autoclave for purposes of full curing at high pressure and temperatures of up to 220° C. The removal of the bonded component from the device represents the final production step.

Voids represent a major difficulty in the production of integrally reinforced shells; these are already present within the device, or occur only during the curing process. Matrix material can penetrate into these voids; in turn this leads to a reduction of the material thickness of other parts of the shell, i.e., of the bonded component. Bonded components, whose material thickness is significantly less than a prescribed value less a tolerance, which as a rule is small, must usually undergo complex further treatment, which leads to significant extra costs.

A multiplicity of effects are responsible for the occurrence or existence of such cavities. Thus, for example, during the curing process the cavity formed by the molding tools and the overlying vacuum generation system is filled with the fiber-reinforced plastic that has been introduced, in particular with its matrix material. In addition to the form-defining cavity that is required for the design of the bonded component, further undesirable cavities are present. These voids essentially ensue as a result of gaps and/or capillaries between the individual molding tools. Furthermore empty spaces ensue as a result of volumes underneath the molding tools that are not filled, as caused by deviations of size and/or location of the laminates, deviations of size and/or location of the molding tools, and also the thermal expansion of the molding tools during the curing process. In the event of a temperature variation of 160° C. a molding tool made of an aluminum alloy and with a length of 4 m, experiences, for example, an expansion of approx. 15 mm. Furthermore undesirable voids can also form within the vacuum generation system, for example as a result of a vacuum envelope that is not fully attached.

### SUMMARY OF THE INVENTION

The object of the invention is therefore to create a device and also a method for the production of large-format components that are spatially of complex shape and integrally reinforced with fiber-reinforced plastics using molding tools exhibiting high thermal expansion, in which undesirable cavities only occur to a significantly reduced extent.

In that at least one filler element is fitted to each of the two end faces of the base laminate in an essentially gap-free manner, the increasing level of projection of the bonded component laminates as a result of the severe expansion of the molding tools during the heating phase of the curing process no longer leads to voids into which uncontrolled matrix material can penetrate. In addition the filler elements serve as supports for the molding tools and by this means reduce their level of bending, in particular under high pressures in autoclaves.

In accordance with an advantageous development of the device, provision is made that at least one sealing element is inserted between each of the filler elements and the end faces of the base laminate in an essentially gap-free manner.

As a consequence of the edge sealing of the bonded component with the aid of the sealing elements, a possible transfer of matrix material into the vacuum generation system, i.e., into the voids formed by the vacuum generation system, is reduced. Furthermore the sealing elements enable a reduction of possible voids as a result of any deviations of location and/or size of the laminates, and also of the molding tools. The sealing elements are positioned in a gap-free manner between the two end faces of the base laminate and the filler elements. Reinforcement laminates, such as, for example, stringer laminates with the associated molding tools, do not lead to any conflict, because the sealing elements are compressed and/or displaced as required.

In accordance with a further advantageous configuration of the device the at least one molding tool in particular exhibits high thermal expansion.

The insensitivity of the device to molding tools exhibiting high thermal expansion, as provided by the filler elements and also the sealing elements, enables the use of cost-effective molding tools made of aluminum alloys.

In accordance with a further development of the device a material thickness of the at least one filler element and of the at least one sealing element approximately corresponds in each case to a material thickness of the base laminate and the reinforcement laminate.

By this means the at least one molding tool is provided with support over as much surface area as possible by the laminates, the sealing elements and the filler elements.

In a further advantageous configuration of the device provision is made that the filler elements are formed from a metallic material and/or from a plastic material.

This ensures that the filler elements durably withstand the extreme ambient conditions that prevail in the autoclave during the curing process. The filler elements can, for example, be formed from an aluminum alloy, a titanium alloy, or a stainless steel alloy. Alternatively the filler elements can also be manufactured from a thermosetting or a thermoplastic plastic material that has a sufficient mechanical load capacity at high temperatures of up to 250° C. For purposes of increasing the mechanical and thermal load capacity the plastic material can be fitted with fiber reinforcements.

In accordance with a further development of the device the at least one sealing element is formed from an elastic material, in particular from a mixture of rubber and cork.

By virtue of this mixture sufficient pressure and temperature stability is provided in the first instance. In addition the material mixture cited has a sufficiently high elasticity—in particular to compensate for layers missing from the laminates within the device, and/or dimensional deviations of the laminates.

In accordance with a further advantageous configuration provision is made that each of the filler elements and the sealing elements has an approximately rectangular cross-sectional geometry.

As a consequence of this geometrical configuration seating between the molding tools and the base molding tool ensues over a large surface area. In addition this design permits the simple manufacture of filler elements and sealing elements by the manufacture of sections of the required length from “continuous” semi-finished products.

In accordance with a further configuration of the device both end sections of the at least one molding tool rest on the filler elements, at least in some regions.

By this means, among other factors, any downwards bending of the end sections of the molding tools projecting beyond the laminates on both sides is avoided, if the device is subjected to a high ambient pressure, such as, for example, in an autoclave during the curing process of the bonded component.

In the course of the inventive method at least one base laminate is placed and aligned on the base molding tool in the first instance. At least one sealing element is then arranged in the region of each of the two end faces of the base laminate in an essentially gap-free manner. At least two filler elements are then likewise applied onto the two sealing elements in an essentially gap-free manner. In an intermediate step preformed reinforcement laminates with the associated molding tools are then laid down on the base laminate. After that the molding tools are provided with a release layer, which is overlaid with an aeration material. The whole assembly is then covered with a vacuum envelope to complete the device. The vacuum envelope can be subjected to a reduced pressure via at least one vacuum channel with at least one perforated covering accommodated therein. For purposes of curing the bonded component, formed from the at least one base laminate and the at least one reinforcement laminate, by the application of pressure and temperature, the whole device is placed in an autoclave.

### BRIEF DESCRIPTION OF THE DRAWINGS

In the drawings:

FIG. 1 shows a cross-sectional representation through an arrangement of known prior art for the production of components of fiber-reinforced plastic, which leads to undesirable voids.

FIG. 2 shows a longitudinal section through the arrangement in accordance with FIG. 1 along the section line II-II in FIG. 1,

FIG. 3 shows a schematic longitudinal section through the inventive device for purposes of reducing the voids that are caused by thermal expansion, among other factors, and

FIG. 4 shows the device in accordance with the longitudinal section in FIG. 3 with voids as a consequence of, in particular, incorrectly positioned laminates.

In the drawings the same design elements have the same reference numbers in each case.

### DETAILED DESCRIPTION OF THE PREFERRED EMBODIMENTS

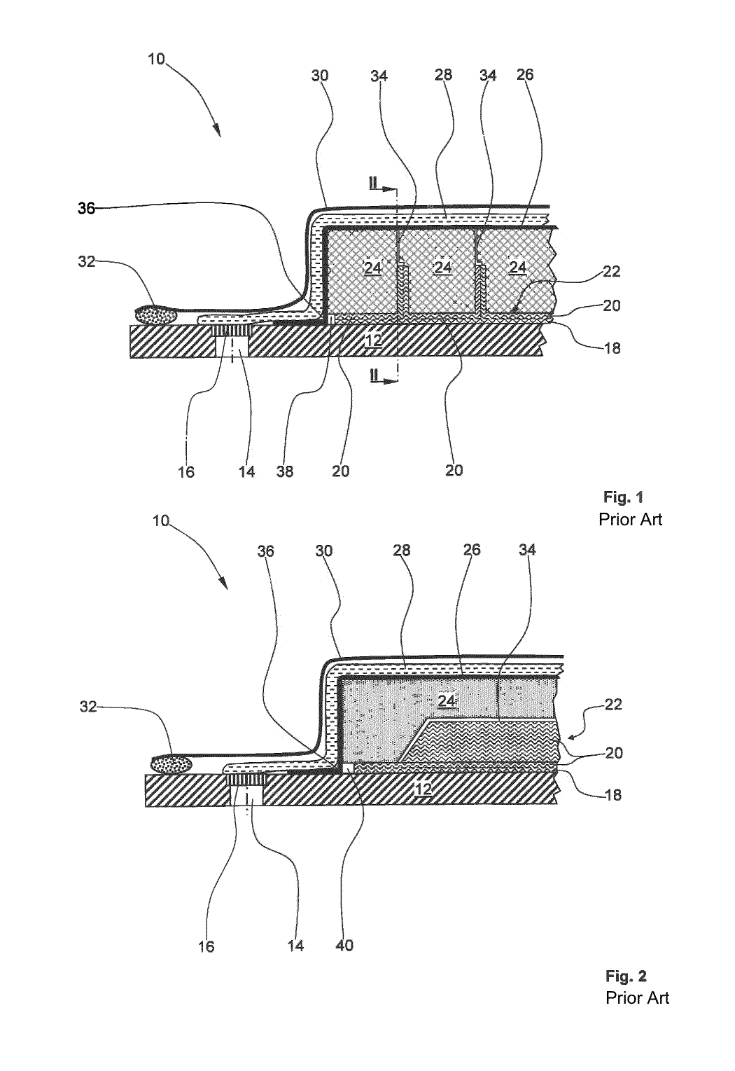

FIG. 1 shows a schematic cross-section through an arrangement of known prior art for the manufacture of components of fiber-reinforced plastic, while FIG. 2—to which reference is made at the same time—illustrates a simplified longitudinal section through the arrangement in accordance with the section line II-II in FIG. 1.

The arrangement 10 comprises, among other items, a base molding tool 12 with a vacuum channel 14 with a perforated covering 16. On the base molding tool 12 is located a base laminate 18, on which three reinforcement laminates 20 are laid down; together these form the bonded component 22. The spatial geometry of the reinforcement laminates 20 is here defined by means of three molding tools 24, i.e., cores. On the molding tools 24 runs a release layer 26, which for its part is covered with an aeration material 28, i.e., an aeration mat. The aeration material 28 is for its part covered with a vacuum envelope 30, which by means of a seal 32 is sealed in a gas-tight manner with respect to the base molding tool 12 and forms a vacuum generation system that is not designated. The at least one base laminate 18 and also the reinforcement laminates 20 are formed from a fiber-reinforced plastic. A prepreg material made up from an epoxy resin reinforced with carbon fibers can, for example, find application as the fiber-reinforced plastic. As a result of the effects elucidated in the introduction undesirable voids exist, or form during the curing process of the bonded component 22—in which the whole arrangement 10 is usually placed in an autoclave, and a reduced pressure prevails within the vacuum envelope 30, at least for some of the time.

As can be seen from FIGS. 1, 2, two voids 34 exist in each case between the molding tools 24, and a further void 36 in the form of a gusset is located underneath the aeration material 28 within the vacuum generation system. The other voids 38, 40 are to be attributed to, among other factors, thermal expansion effects of the molding tools 24 and/or the base molding tool 12 in the course of the curing process in the autoclave. In particular matrix material can penetrate into the voids 34, 38, 40, as a result of which a material thickness of the bonded component 22 can be reduced to the extent that this, less the prescribed tolerance, lies below a limiting value, and complex rework is required in order to bring the bonded component 22 up to the required minimum design thickness.

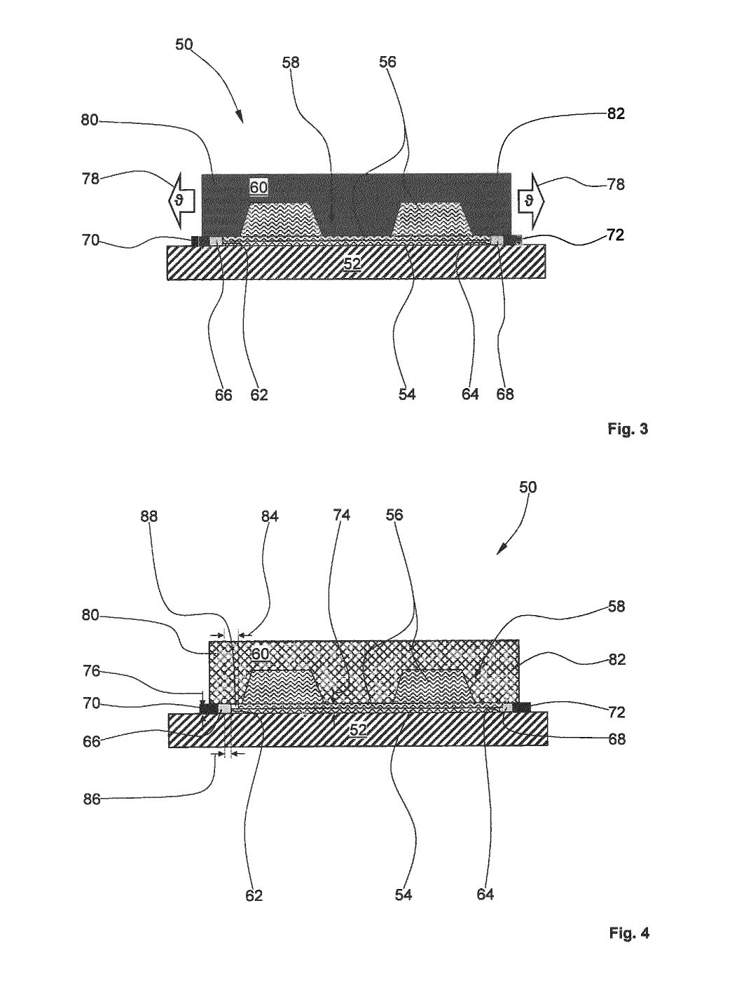

FIG. 3 and FIG. 4—to which reference is made at the same time in the further course of the description—in a presentation of the principles illustrate a schematic longitudinal section through an inventively configured device for purposes of extensively reducing cavities caused by thermal expansion as well as for purposes of reducing voids as a result of deviations in the locations of the laminates. In the interests of improving the clarity of the drawing the vacuum generation system is not represented in FIGS. 3, 4.

A device 50 comprises, among other items, a base molding tool 52, on which rest at least one base laminate 54 and one reinforcement laminate 56, such as, for example, a stringer laminate. The base laminate 54 and the reinforcement laminate 56 together form the bonded component 58 that is to be produced; this is formed with fiber-reinforced plastics, and as a rule takes the form of a shell with integral reinforcement. The bonded component 58 is covered with at least one forming, i.e., form-defining molding tool 60, which in comparison to the base molding tool 52 exhibits high thermal expansion. The molding tool 60 can, for example, be formed from an aluminum alloy, while the base molding tool 52 is manufactured from a steel alloy or a stainless steel alloy. At least one sealing element 66, 68 and also at least one filler element 70, 72 is fitted to each of the two end faces 62, 64 of the base laminate 54, at least in some sections, in an essentially gap-free manner. Both the sealing elements 66, 68 and also the filler elements 70, 72 have an approximately rectangular cross-sectional geometry. A material thickness 74 of the base laminate 54 and the reinforcement laminate 56 together approximately correspond to a material thickness 76 of the sealing elements 66, 68 and/or the filler elements 70, 72.

The sealing elements 66, 68 are preferably manufactured from a mixture of cork and rubber. The filler elements 70, 72 are formed from a metallic material and/or from a suitable plastic material, which can withstand the pressure and temperature conditions prevailing in the autoclave. The filler elements 70, 72 can consist of an aluminum alloy, a titanium alloy, a steel alloy, or a stainless steel alloy.

In the further course of the description reference is first made to FIG. 3. Even in the event of severe thermal expansion 78 of the molding tool 60—such as usually occurs in the autoclave during the curing process—both end sections 80, 82 of the (upper) molding tool 60 rest on the filler elements 70, 72, at least in some regions. Accordingly the increasing level of projection of the laminates 54, 56, i.e., of the bonded component 58, as a result of the expansion of the molding tool 60 during the heating phase in the autoclave, no longer leads to voids. In addition the filler elements 70, 72 serve as supports for the molding tool 60 on both sides and by this means reduce its (cantilevered) bending downwards as a result of the high pressure prevailing in the autoclave.

On the basis of the representation in FIG. 4 the sealing elements 66, 68 reduce any possible transfer of matrix material into the vacuum generation system, not represented here, i.e., into the voids formed by the vacuum generation system. Furthermore the sealing elements 66, 68 achieve a reduction of any voids as a result of deviations of location and/or size 84, 86 of the laminates 54, 56 and of the molding tool 60. Thus, for example, the volume of a cavity 88 as a consequence of a horizontal location error (displacement) of the reinforcement laminate 56 is limited by means of the sealing elements 66, and by this means its undesirable ability to accommodate matrix material from the bonded component 58 is at least reduced. The sealing elements 66, 68 are preferably applied, i.e., positioned, onto the base laminate 54 in a gap-free manner after the base laminate 54 has been laid down on the base molding tool 52. The reinforcement laminates 56, supported, at least in some sections, on the sealing elements 66, 68, after application as required, do not lead to any conflict, since the sealing elements 66, 68 can be compressed and/or displaced by virtue of their elasticity.

The thermal expansion 78 (cf. FIG. 3) in the longitudinal direction of the device 50 as shown, is very much greater than the thermal expansion transverse to the longitudinal direction (at right angles to the plane of the drawing), not represented, because a length of the device 50 of for example, 5 m is significantly greater than its width of for example, 0.5 m. Nevertheless filler elements and/or sealing elements can also be provided on at least one longitudinal face of the laminates 54, 56 within the device 50, at least in some sections, in order to achieve the above-elucidated effects, in particular in the form of a reduction of voids.

The sequence of the inventive method for the manufacture of a complex shaped component with fiber-reinforced plastics, for example of an integrally reinforced shell component of CFRP, will be elucidated in more detail in what follows with the aid of FIGS. 3, 4. At least one base laminate 54 is laid down on the base molding tool 52 in the first instance. After that the sealing elements 66, 68 and also the filler elements 70, 72 are applied to the end faces 62, 64 of the base laminate 54 in a manner that is as free of gaps as possible. The at least one reinforcement laminate 56 together with the associated form-defining molding tool 60, i.e., core, is then laid down on the base laminate 54. The arrangement thus created is provided with a conventional vacuum generation system, not represented, which is preferably formed with at least one release layer, at least one aeration layer running over the latter, and one vacuum envelope closing everything off from the external environment. In addition the vacuum generation system can have further layers, such as, for example, layers for the removal of resin by suction, or tear-off layers. Furthermore fixing means, such as, for example, adhesive tapes or similar, are necessary in order to secure the above-mentioned elements on the base molding tool 52 and to prevent slippage of the elements relative to one another. The space underneath the vacuum envelope is then at least partially evacuated via a vacuum channel with a perforated covering. The device 50 thus formed is then placed in an autoclave, in which the curing of the laminates 54, 56 to form a finished bonded component 58 takes place with the simultaneous application of pressure and temperature. During the curing process in the autoclave the reduced pressure within the vacuum envelope can be reduced with time to the extent that normal ambient air pressure prevails in the latter.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### REFERENCE SYMBOL LIST

10. Arrangement
12. Base molding tool
14. Vacuum channel
16. Perforated covering
18. Base laminate
20. Reinforcement laminate
22. Bonded component
24. Molding tool
26. Release layer
28. Aeration material
30. Vacuum envelope
32. Seal
34. Void (molding tool)
36. Void (vacuum generation system)
38. Void
40. Void
50. Device
52. Base molding tool
54. Base laminate
56. Reinforcement laminate
58. Bonded component
60. Molding tool
62. End face (base laminate)
64. End face (base laminate)
66. Sealing element
68. Sealing element
70. Filler element
72. Filler element
74. Material thickness
76. Material thickness
78. Thermal expansion
80. End section
82. End section
84. Location deviation (laminate)
86. Size deviation (laminate)
88. Cavity

1-9. (canceled)

10. A device for the manufacture of a bonded component with fiber-reinforced plastics comprising:
at least one base molding tool and at least one molding tool,
the bonded component being arranged between the base molding tool and the molding tool,
the bonded component having at least one base laminate and at least one reinforcement laminate,
the molding tool being covered with an aeration material and with a vacuum envelope,
the vacuum envelope being sealed with respect to the base molding tool, and
at least one filler element being fitted to each of the two end faces of the base laminate in an essentially gap-free manner.

11. The device in accordance with claim 10, wherein at least one sealing element is inserted in each case between the filler elements and the end faces of the base laminate in an essentially gap-free manner.

12. The device in accordance with claim 10, wherein the at least one molding tool exhibits high thermal expansion.

13. The device in accordance with claim 10, wherein a material thickness of the at least one filler element and the at least one sealing element in each case approximately corresponds to a material thickness of the base laminate and the reinforcement laminate.

14. The device in accordance with claim 10, wherein the filler elements are formed from at least one of a metallic material and a plastic material.

15. The device in accordance with claim 10, wherein the at least one sealing element is formed from an elastic material.

16. The device in accordance with claim 15, wherein the elastic material is a mixture of rubber and cork.

17. The device in accordance with claim 10, wherein the filler elements and the sealing elements have in each case an approximately rectangular cross-sectional geometry.

18. The device in accordance with claim 10, wherein the at least one molding tool with the two end sections rests on the filler elements, at least in some regions.

19. A method for the manufacture of a bonded component with fiber-reinforced plastics using the device in accordance with claim 10.
